(19) United States
(12) Patent Application Publication
(10) Pub. No.: US 2010/0158265 A1
(43) Pub. Date: Jun. 24, 2010

(54) Headphones with interchangeable connectors

(75) Inventor: Robert Riese, San Clemente, CA (US)

Correspondence Address: NIXON & VANDERHYE, PC, 901 NORTH GLEBE ROAD, 11TH FLOOR, ARLINGTON, VA, 22203, US

(73) Assignee: GSM (TRADEMARKS) PTY LTD, Burleigh Heads (AT)

(21) Appl. No.: 12/654,270

(22) Filed: Dec. 15, 2009

Related U.S. Application Data
(60) Provisional application No. 61/193,672, filed on Dec. 15, 2008.

(51) Int. Cl. H04R 1/10

(52) U.S. Cl. 381/74

(57) ABSTRACT

Headphones include two common headphone speakers; and at least first and second interchangeable connectors adapted to be selectively and removably attached to the headphone speakers. The first connector includes a head harness structured to interconnect the two headphone speakers and the second connector includes a clip structure structured to individually attach to each of the headphone speakers and individually clip each of the headphone speakers to a strap adjacent a user's ear when in use.

### CROSS-REFERENCE TO RELATED APPLICATION

This application claims the benefit of U.S. Provisional Application No. 61/193,672, filed Dec. 15, 2008, which is incorporated herein by reference in its entirety.

### FIELD OF THE INVENTION

The present invention relates to headphones.

### BACKGROUND OF THE INVENTION

Headphones are known in the art. The present invention provides improvements to known headphones to enhance usability.

### SUMMARY OF THE INVENTION

One aspect of the invention relates to headphones including two common headphone speakers and at least first and second interchangeable connectors adapted to be selectively and removably attached to the headphone speakers. The first connector includes a head harness structured to interconnect the two headphone speakers and the second connector includes a clip structure structured to individually attach to each of the headphone speakers and individually clip each of the headphone speakers to a strap adjacent a user's ear when in use.

Another aspect of the invention relates to a method for fitting headphones to a user. The method includes providing two common headphone speakers with connector attachment points, selecting one of a head harness structured to interconnect the two headphone speakers or a clip structure structured to individually clip each of the headphone speakers to a strap adjacent a user's ear when in use, and removably attaching the selected head harness or clip structure to the two headphone speakers.

Other aspects, features, and advantages of this invention will become apparent from the following detailed description when taken in conjunction with the accompanying drawings, which are a part of this disclosure and which illustrate, by way of example, principles of this invention.

### BRIEF DESCRIPTION OF THE DRAWINGS

The accompanying drawings facilitate an understanding of the various embodiments of this invention. In such drawings:

FIG. 1 is a perspective view of headphones with an interchangeable head harness according to an embodiment of the present invention;

FIG. 2 is a front view of the headphones of FIG. 1;

FIG. 3 is a top view of the headphones of FIG. 1;

FIG. 4 is a front view of headphones with an interchangeable clip structure according to an embodiment of the present invention;

FIG. 5 is a top view of the headphones of FIG. 4;

FIG. 6 is a side view of the headphones of FIG. 4;

FIG. 7 illustrates the headphones of FIG. 4 clipped to a goggle strap according to an embodiment of the present invention;

FIG. 8 is a front view of a headphone speaker according to an embodiment of the present invention;

FIG. 9 is a side view of the headphone speaker of FIG. 8;

FIG. 10 is a top view of the headphone speaker of FIG. 8;

FIG. 11 is an exploded view of the headphones of FIG. 1 showing the removable connection of the head harness to the headphone speaker according to an embodiment of the present invention;

FIG. 12 is a rear view of a clip structure according to an embodiment of the present invention;

FIG. 13 is an exploded view of the headphones of FIG. 4 showing the removable connection of the clip structure to the headphone speaker according to an embodiment of the present invention;

FIG. 14 is a perspective view of headphones with an interchangeable clip structure according to another embodiment of the present invention;

FIG. 15 is a side view of the headphones of FIG. 14;

FIG. 16 is a front view of the headphones of FIG. 14;

FIG. 17 is a top view of the headphones of FIG. 14;

FIG. 18 is an exploded view of the headphones of FIG. 14 showing the removable connection of the clip structure to the headphone speaker according to an embodiment of the present invention;

FIG. 19 illustrates the headphones of FIG. 14 clipped to a goggle strap according to an embodiment of the present invention; and

FIG. 20 is a schematic view showing a headphones cable arrangement according to an embodiment of the present invention.

### DETAILED DESCRIPTION OF ILLUSTRATED EMBODIMENTS

The following description is provided in relation to several embodiments which may share common characteristics and features. It is to be understood that one or more features of any one embodiment may be combinable with one or more features of the other embodiments. In addition, any single feature or combination of features in any of the embodiments may constitute additional embodiments.

1. Headphones with Interchangeable Connectors

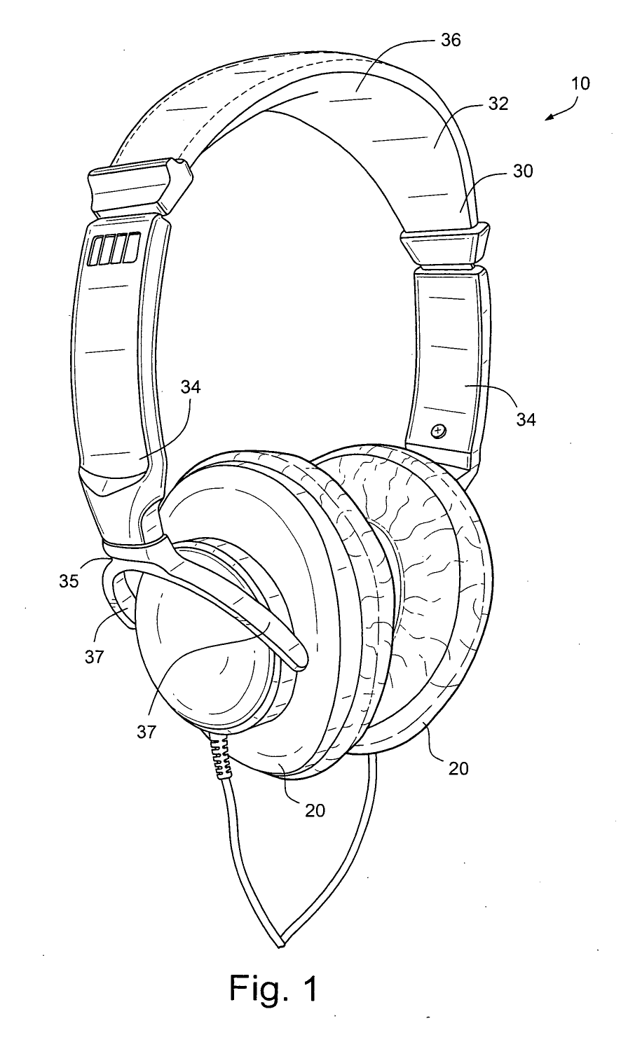

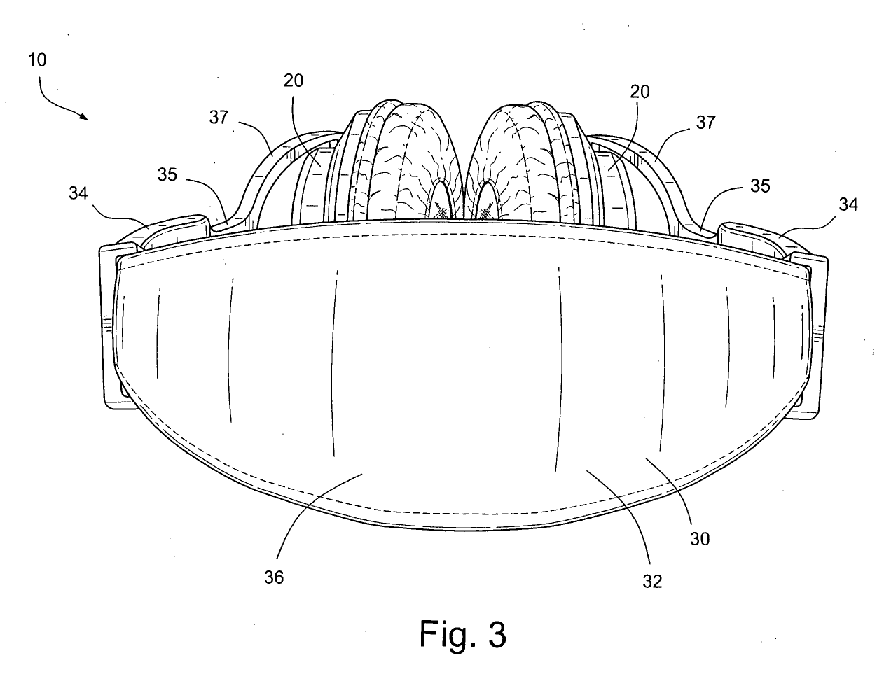

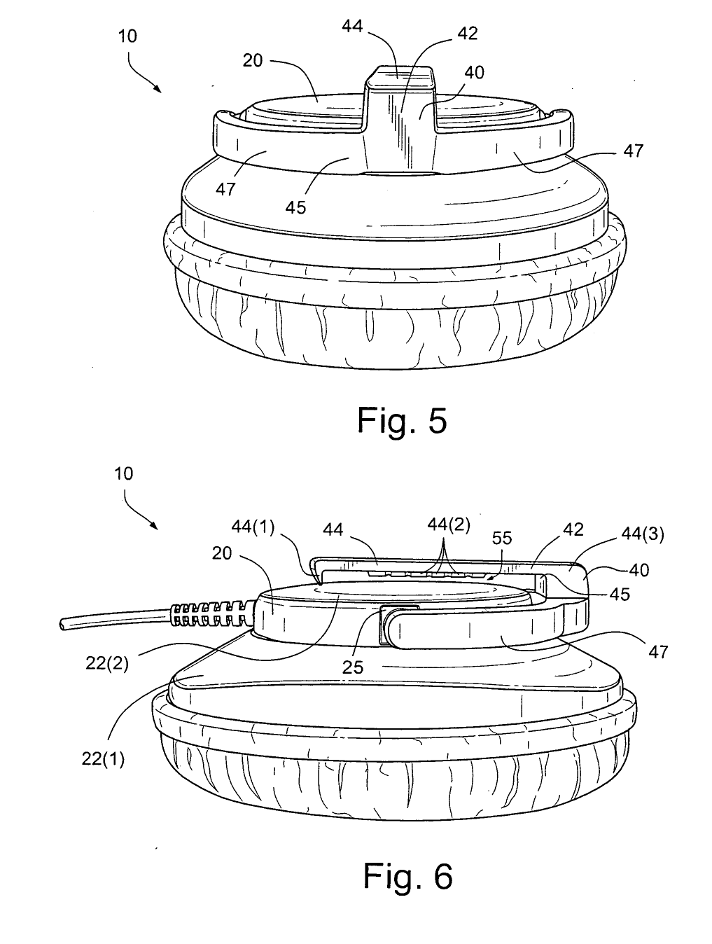

FIG. 1-7 illustrate headphones 10 with interchangeable connectors 30, 40 according to an embodiment of the present invention. The headphones 10 includes two common or universal headphone speakers or ear pieces 20 (e.g., audio speakers adapted to electrically communicate with an audio signal) and one of two connectors 30, 40 removably attachable to the headphone speakers 20.

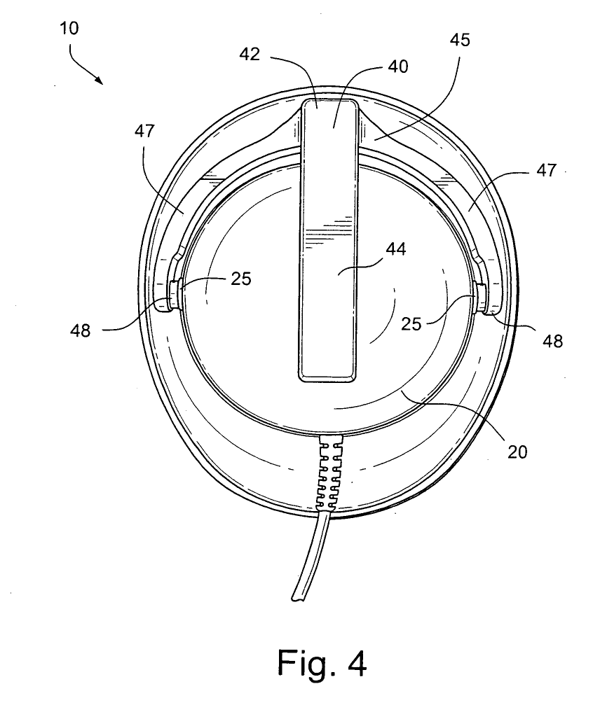

In the illustrated embodiment, one of the connectors 30 is a head harness 32 (over-the-head connecting portion or bridge) structured to interconnect the two headphone speakers 20 (FIGS. 1-3), and the other of the connectors 40 is a clip structure 42 provided to each headphone speaker 20 and structured to individually clip each headphone speaker 20 to a strap 50 adjacent a user's ear when in use, e.g., goggle strap, sunglass strap, etc. (FIGS. 4-7).

This interchangeable or convertible arrangement allows two connection structures to be used with the headphone speakers 20 depending on the user's preference and/or activity. For example, the clip structure 42 may be used with the headphone speakers 20 for active use (e.g., headphone speakers clip to goggle strap during skiing or snowboarding) and the head harness 32 may be used with the headphone speakers 20 for casual use.

While the headphones is described as including two different connectors, it should be appreciated that the headphones may include any suitable number of connectors, e.g., two, three, or more connectors. For example, different head harness and/or clip structure arrangements may be usable with the headphones.

### 1.1 Headphone Speakers

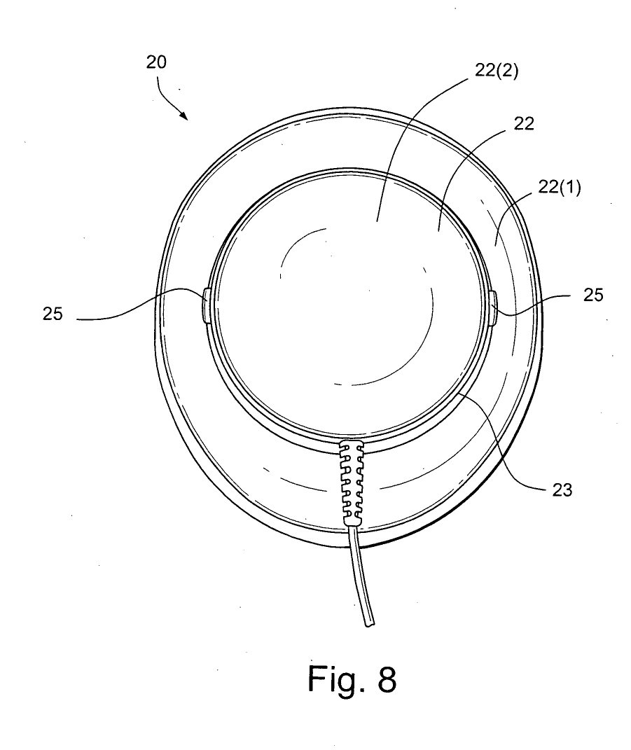

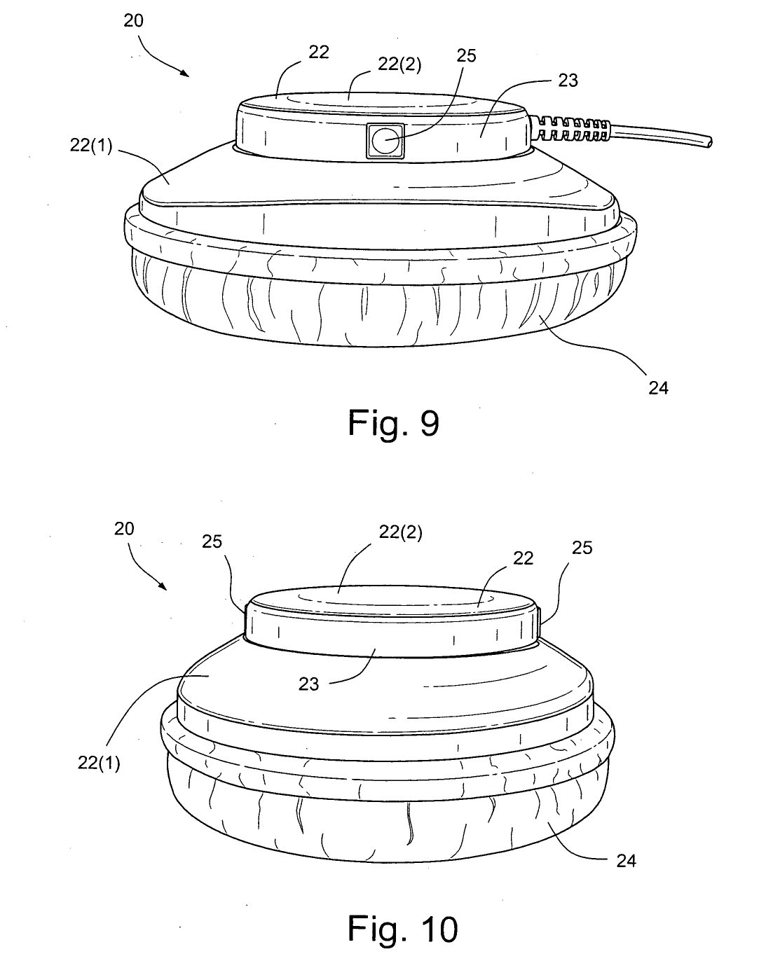

As best shown in FIGS. 8-10, each of the headphone speakers 20 includes a base 22, an ear cushion 24, and an audio unit (not shown) to produce sound. In the illustrated embodiment, the base 22 includes a first portion 22(1) adapted to support the ear cushion 24 and a second portion 22(2) that is raised with respect to the first portion 22(1) and adapted to removably engage each of the connectors 30, 40.

As illustrated, the second portion 22(2) includes a circular configuration and provides an annular side wall 23. Diametrically opposed openings 25 are provided in the side wall 23 for receiving respective pins provided to the connectors 30, 40 as described below.

In the illustrated embodiment, the headphone speakers 20 are of the type that sit or lie on the user's ear. However, it should be appreciated that aspects of the invention may be applicable to other types of headphone speakers, e.g., headphone speakers that surround or enclose the user's ear, insert into the user's ear, etc.

### 1.2 Head Harness

As shown in FIGS. 1-3, the connector 30 in the form of head harness 32 includes end portions 34 and a connecting portion 36 to interconnect the end portions 34. The head harness 32 is structured to provide a biasing force to bias the headphone speakers 20 towards one another for engaging against the user's ears in use.

The end portions 34 may be movably coupled to the connecting portion 36 to allow relative movement between the end portions 34 and the connecting portion 36. For example, the end portions 34 may be slidably coupled to the connecting portion 36 (e.g., for length adjustment) and/or the end portions 34 may be pivotally coupled to the connecting portion 36 (e.g., for folding into a more compact, storage position).

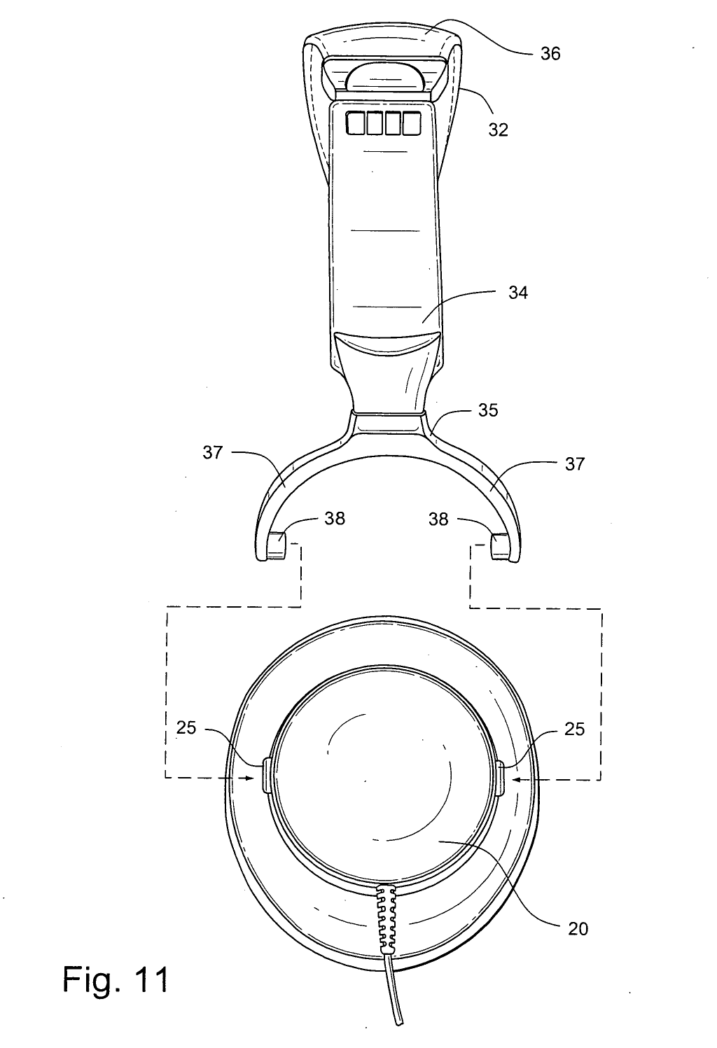

Each end portion 34 includes a speaker support 35 structured to support a respective headphone speaker 20. In the illustrated embodiment, the speaker support 35 includes two arms or forks 37 each containing an inwardly directed pin 38 adjacent the free end. The two forks 37 are structured to movably retain the headphone speaker 20 therebetween, i.e., pins 38 received and supported within respective openings 25 provided in the headphone speaker 20 as shown in FIG. 11. The forks 37 are resiliently deflected apart from one another during assembly/disassembly, e.g., so that the pins 38 are biased into respective openings 25 with a snap-fit.

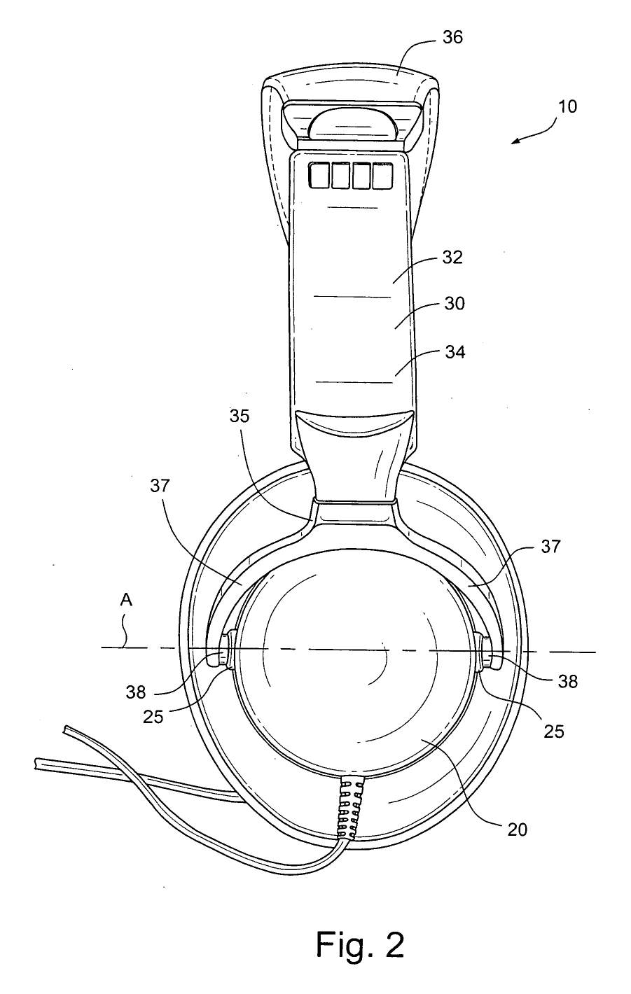

This arrangement movably couples the two headphone speakers 20 to respective ends of the head harness 32. Specifically, each headphone speaker 20 may pivot with respect to the head harness 32 about axis A as shown in FIG. 2. This arrangement allows the headphones to adapt to different sizes and shapes of user heads.

### 1.3 Clip Structure

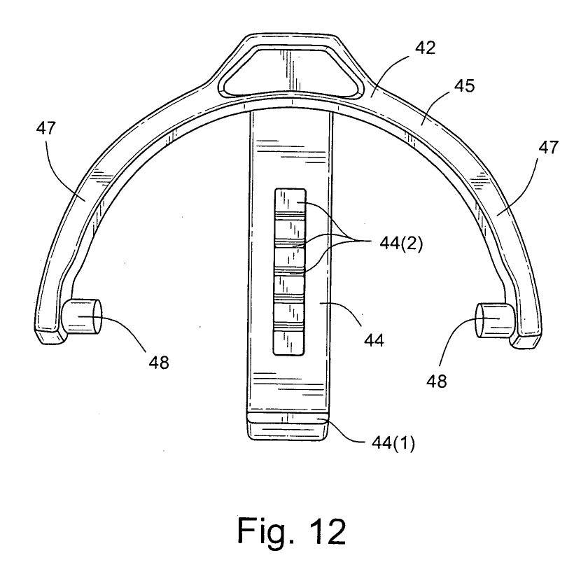

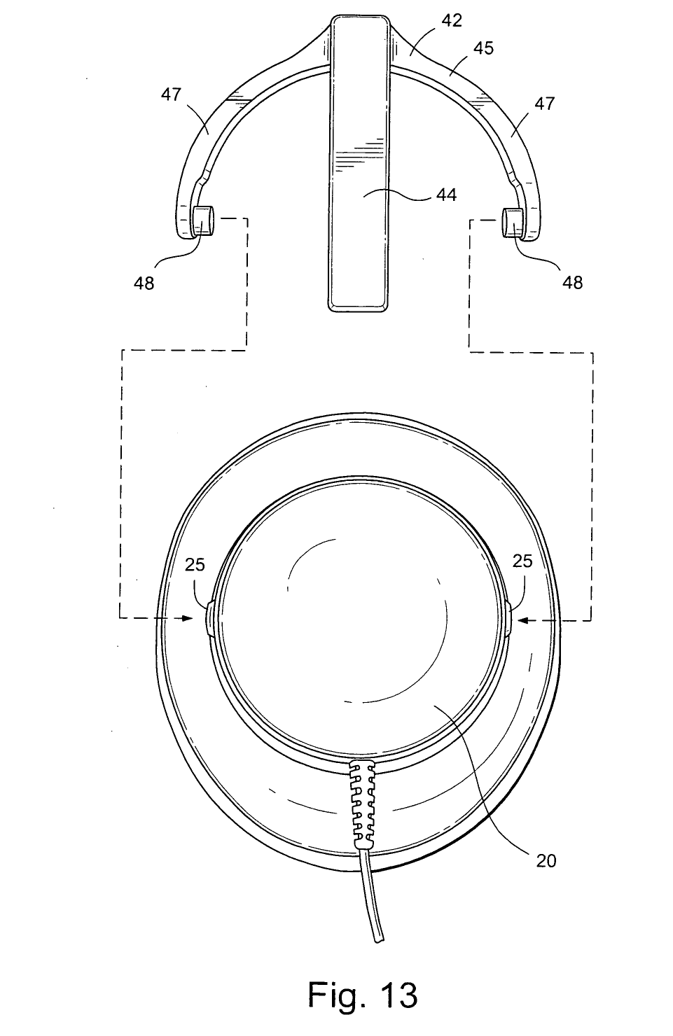

As shown in FIGS. 12 and 13, the connector 40 in the form of clip structure 42 (or attachment clip) includes a speaker support 45 similar to that of the head harness, i.e., two arms or forks 47 each containing an inwardly directed pin 48 adjacent the free end. The two forks 47 are structured to movably retain a respective headphone speaker 20 therebetween, i.e., pins 48 received and supported within respective openings 25 provided in the headphone speaker 20 as shown in FIG. 13. The forks 47 are resiliently deflected apart from one another during assembly/disassembly, e.g., so that the pins 48 are biased into respective openings 25 with a snap-fit.

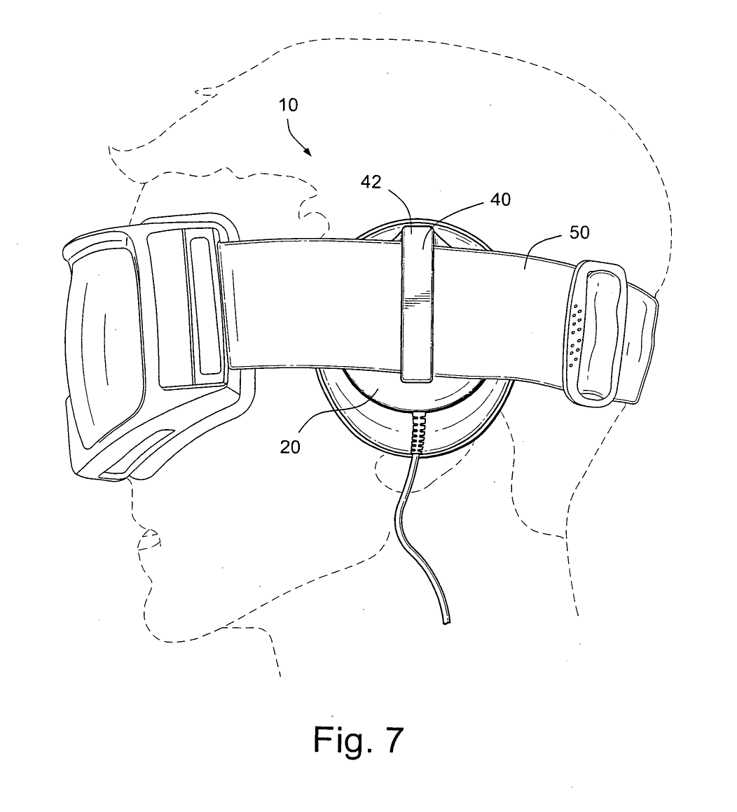

In addition, the clip structure 42 includes a clip 44 extending from an intermediate portion connecting the forks 47. As shown in FIG. 7, the clip 44 allows the headphone speaker 20 to be clipped onto a strap 50 adapted to pass adjacent a user's ear when in use (e.g., goggle strap for skiing or snowboarding). The free end of the clip 44 includes a projection 44(1) and the intermediate portion of the clip includes a series of ridges 44(2), each of which help to retain the clip 44 and hence the headphone speaker 20 to the strap 50 in use (e.g., projection 44(1) overhangs edge of the strap 50 and the ridges 44(2) frictionally engage along the strap width in use).

As best shown in FIG. 6, the strap receiving recess 55 defined between the clip 44 and the second portion 22(2) of the base 22 has a length (i.e. distance between projection 44(1) at distal end of clip 44 and inner edge 44(3) at proximal end of clip 44) and width (i.e., distance between outer surface of second portion 22(2) and inner surface of clip 44) that is selected so that the clip may be used with a wide variety of goggle brands (i.e., goggles having straps of different widths, thicknesses, etc.).

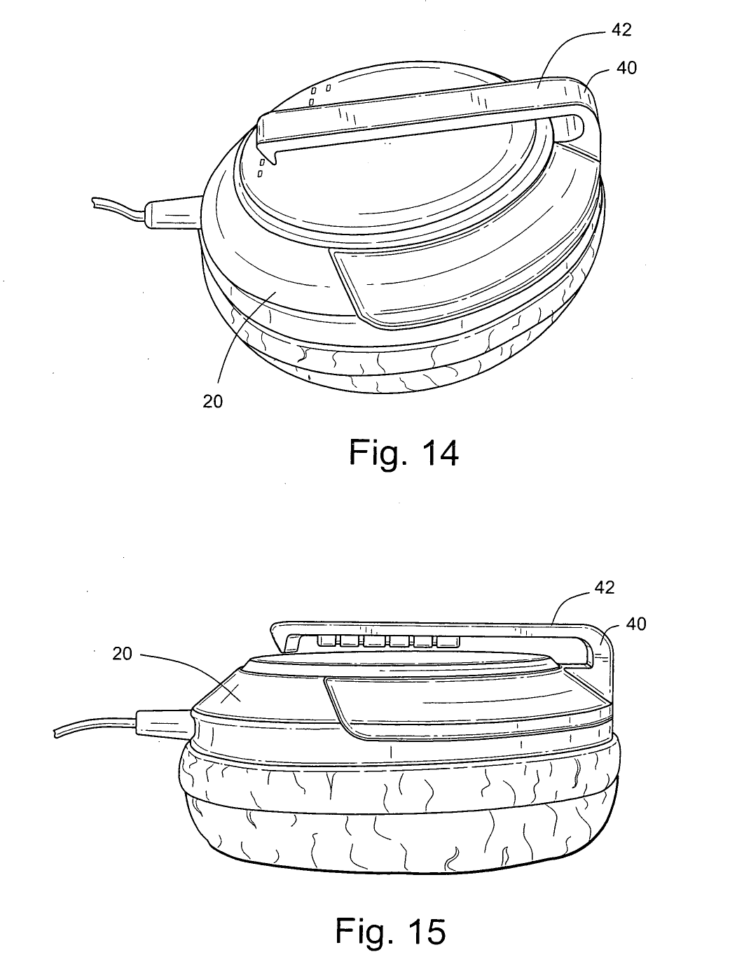

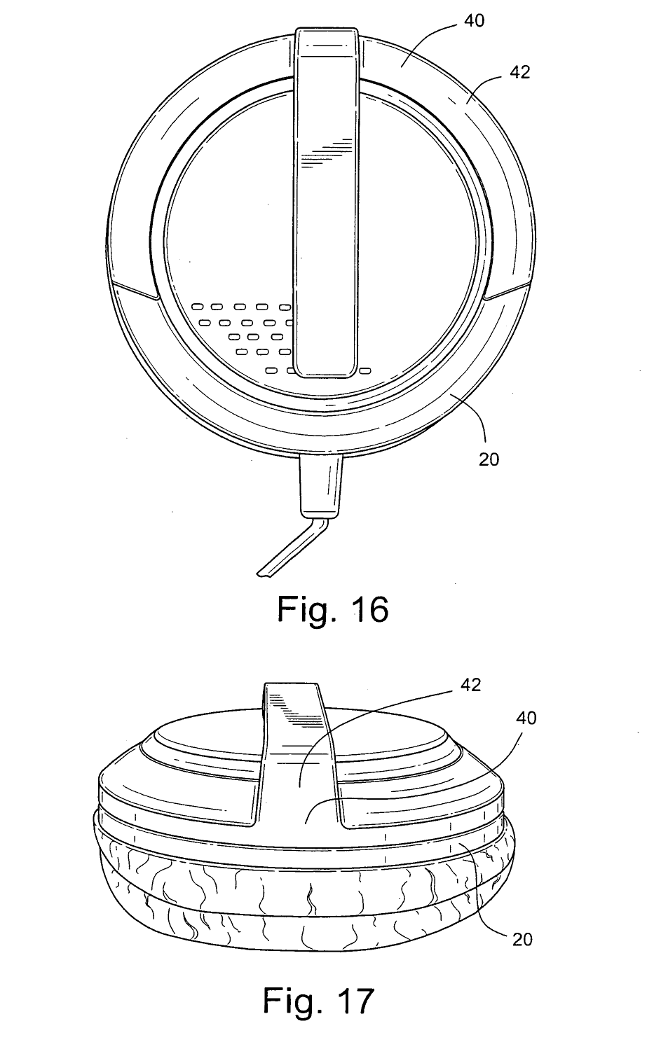

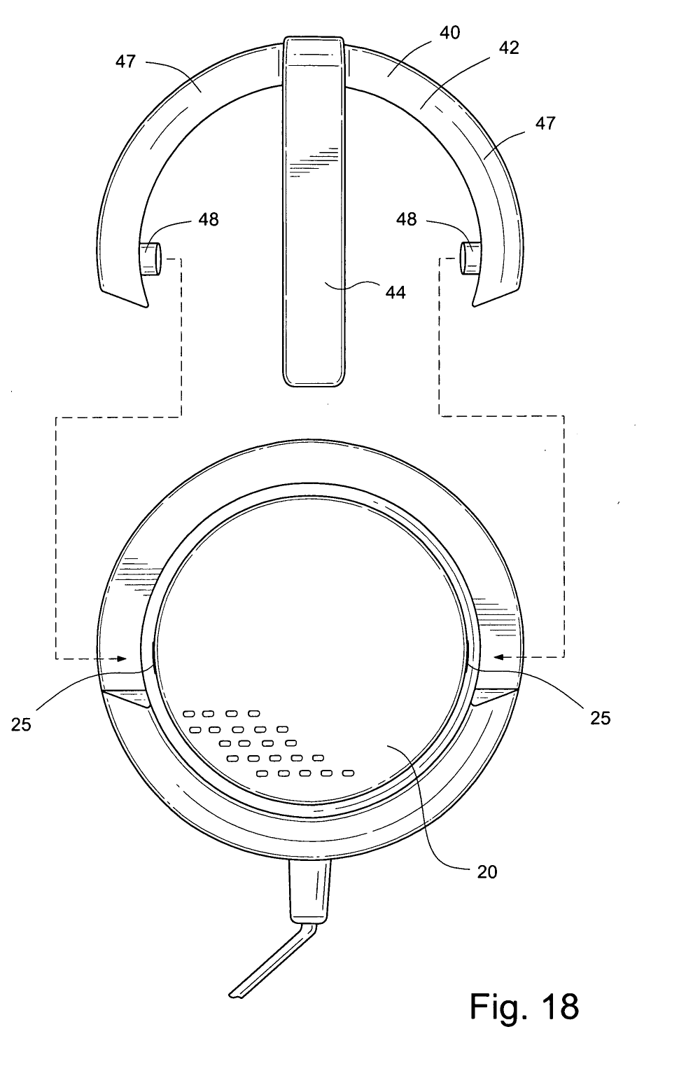

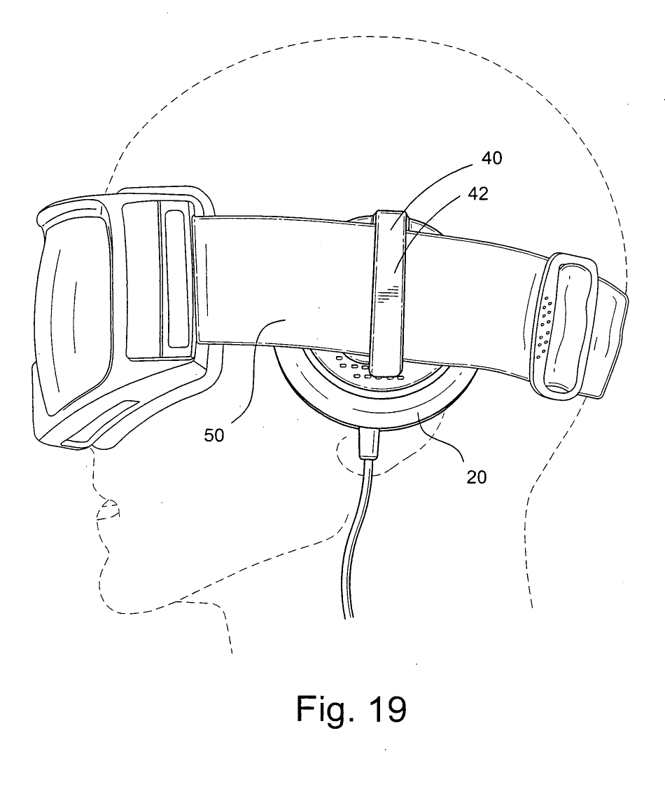

In an alternative embodiment, the forks of the clip and the headphone speaker may be structured so that exterior surfaces of the forks and speaker base are substantially flush with one another when the clip is mounted to the headphone speaker (e.g., see FIGS. 14-19 indicated with similar reference numerals).

### 1.4 Headphones Cable

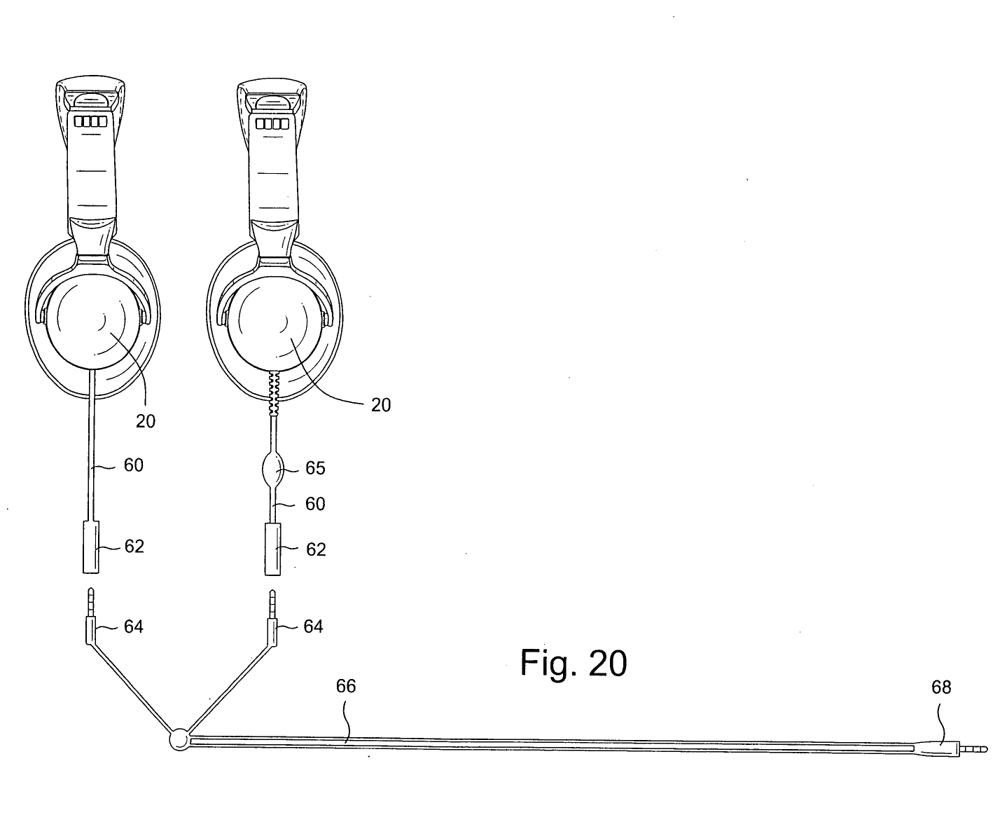

FIG. 20 illustrates an exemplary cable arrangement for coupling the headphone speakers. As illustrated, each headphone speaker may include a short cable 60 (e.g., about 20 cm) with a female plug 62, each female plug 62 adapted to connect to a respective male connector 64 split from one end of a longer cable 66 (e.g., 125 cm). The opposite end of the longer cable 66 includes a male connector 68 for connection with the selected audio device. An inline microphone or volume control 65 may be provided to the short cable 60 of one of the headphone speakers 20.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention. Also, the various embodiments described above may be implemented in conjunction with other embodiments, e.g., aspects of one embodiment may be combined with aspects of another embodiment to realize yet other embodiments. Further, each independent feature or component of any given assembly may constitute an additional embodiment.

What is claimed is:

1. Headphones comprising:
two common headphone speakers; and
at least first and second interchangeable connectors adapted to be selectively and removably attached to the headphone speakers,
the first connector including a head harness structured to interconnect the two headphone speakers and the second connector including a clip structure structured to individually attach to each of the headphone speakers and individually clip each of the headphone speakers to a strap adjacent a user's ear when in use.

2. Headphones according to claim 1, wherein each of the head harness and clip structure includes a speaker support structured to support a respective headphone speaker, the speaker support including two arms or forks each containing an inwardly directed pin adapted to be received and supported within respective openings provided in the headphone speaker.

3. Headphones according to claim 2, wherein the forks of the clip structure and the headphone speaker are structured such that exterior surfaces of the forks and the headphone speaker are substantially flush with one another.

4. Headphones according to claim 1, wherein the clip structure includes a clip, and a free end of the clip includes a projection adapted to overhang an edge of the strap in use.

5. Headphones according to claim 1, wherein the clip structure includes a clip, and an intermediate portion of the clip includes a series of ridges adapted to frictionally engage the strap in use.

6. Headphones according to claim 1, wherein the headphone speakers are of the type that sit or lie on the user's ear in use.

7. A method for fitting headphones to a user, comprising:
providing two common headphone speakers with connector attachment points;
selecting one of a head harness structured to interconnect the two headphone speakers or a clip structure structured to individually clip each of the headphone speakers to a strap adjacent a user's ear when in use; and
removably attaching the selected head harness or clip structure to the two headphone speakers.
